(19) United States
(12) Patent Application Publication
(10) Pub. No.: US 2013/0311892 A1
(43) Pub. Date: Nov. 21, 2013

(54) DIGITAL BUSINESS CARD MANAGEMENT SYSTEM FOR MOBILE DEVICES

(71) Applicant: MENG-FENG HSIEH, KAOHSIUNG CITY (TW)

(72) Inventor: MENG-FENG HSIEH, KAOHSIUNG CITY (TW)

(21) Appl. No.: 13/472,632

(22) Filed: May 16, 2012

(51) Int. Cl. G06F 3/01

(52) U.S. Cl. 715/738

(57) ABSTRACT

A digital business card management system for mobile devices includes several mobile devices and a cloud server. A user can edit a digital business card in a mobile device and upload it to the cloud server. The cloud server allows users who know each other to download each other's digital business card. When the content of a digital business card is changed, the cloud server sends a notification to people with the privilege to view the business card. The invention makes it easier for the user to manage digital business cards and obtain the most up-to-date card information.

### BACKGROUND OF THE INVENTION

1. Field of the Invention

The invention relates to a business card management system and, in particular, to a digital business card management system for mobile devices.

2. Description of Related Art

A business card has the information such as a person's name and the company/institute he or she works for. It is used for people to introduce themselves for first-time meetings or to do businesses. By exchanging business cards, people can get to know each other in the beginning. Moreover, the business card carries contact information (e.g., phone number or E-mail address) for future communications.

Currently, paper business cards are still popular. Most people collect business cards they receive in a card book. They even organize the cards for the convenience of searching. As one knows more people, the number of business cards he or she has also grows. If all the business cards are collected in a single card book, the card book will become very thick and inconvenient for the user to keep or carry. Moreover, it always takes some time to search business cards. In conclusion, using a card book to keep and manage business cards has its disadvantages in practice.

Aside from using a card book, many people also make use of mobile devices (such as smart phones and tablet computers) to maintain the data. Such users have to enter entries one by one into the mobile devices. Since the card data are stored in memory, it is more convenient than the card book. However, if the card information is out of date, the user has to look up for newer, more accurate data and enter them into the mobile device. He or she cannot obtain the most up-to-date data right away. This is the inconvenience.

### SUMMARY OF THE INVENTION

An objective of the invention is to provide a digital business card management system for mobile devices so that its user can more conveniently and quickly manage digital business cards as well as obtain the most up-to-date information.

To achieve the objective, the disclosed digital business card management system for mobile devices includes a plurality of mobile devices and a cloud server.

Each of the mobile devices is installed with an application program that provides a user interface.

The cloud server connects the mobile devices. The cloud server includes a membership database and a business card database. The membership database stores user's personal data. Each user uses the user interface to edit digital business cards and uploads the digital business cards to the business card database.

The cloud server provides a business card sharing function and a business card updating function. The business card sharing function allows person A in the membership database to enter the business card data of person B into person A's mobile device. Person A grants a digital business card viewing privilege to person B. Then person B can immediately browse and download digital business cards of person A from the business card database. When person A updates his or her digital business card, the business card updating function enables the cloud server to send out a notification to people with the privilege to view the digital business card.

The invention achieves the following effects:

1. With the business card sharing function, users who become friends can download each other's digital business cards from the business card database, without entering entries again into their own mobile devices. The convenience is greatly increased.

2. With the business card updating function, friends with the privilege to view a business card will receive a notification that a particular card is updated for download. The user does not need to verify the content of the digital business card or enter the data into his or her own mobile device.

### BRIEF DESCRIPTION OF THE DRAWINGS

FIG. 1 is a system block diagram of a preferred embodiment of the invention;

FIG. 2 is a schematic view of granting the viewing privilege according to the invention;

FIG. 3 is a schematic view of granting the content privilege according to the invention;

FIG. 4 is a schematic view of a map street showing shops matching a search keyword according to the invention.

### DETAILED DESCRIPTION OF THE PREFERRED EMBODIMENT

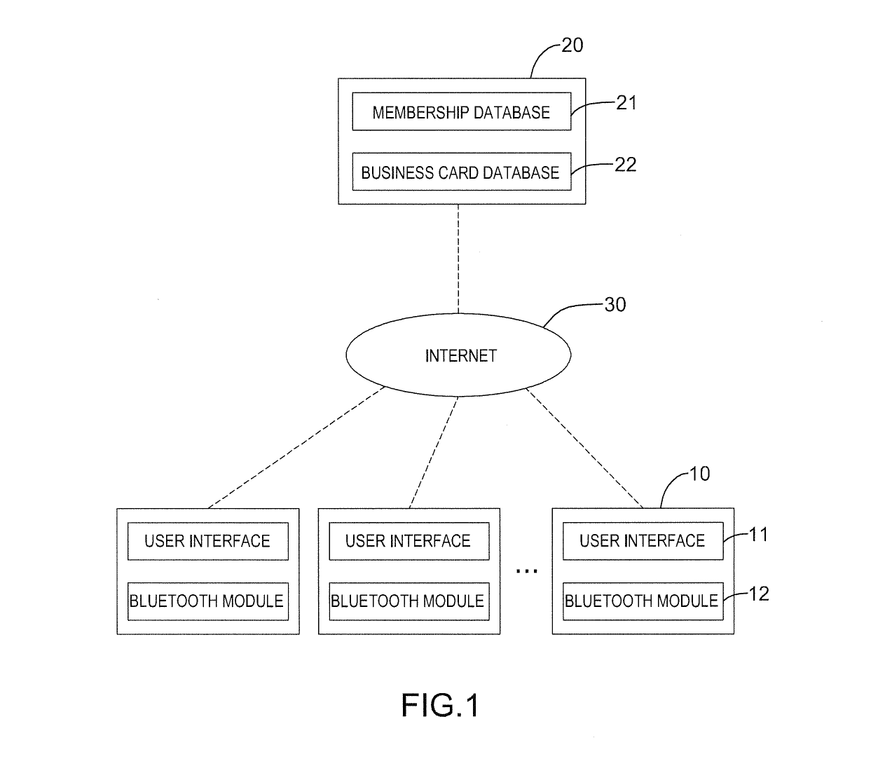

With reference to FIG. 1, a preferred embodiment of the invention includes several mobile devices 10 and one cloud server 20.

Each of the mobile devices 10 is installed with an application program. The application program provides a user interface (UI) 11. The mobile devices 10 herein generally refer to but not limited to such electronic products as smart phones, personal digital assistants (PDA), or tablet computers. The mobile devices 10 can connect to the cloud server 20 via Internet 30.

The cloud server 20 includes a membership database 21 and a business card database 22. A user connects to the cloud server 20 via his or her mobile device 10 and registers as a member. The personal data of the user are stored in the membership database 21. After the user becomes a member, he or she can edit his or her digital business card in the UI 11 and upload the digital business card to the business card database 22. The cloud server 20 assigns a number to each of the digital business cards. The digital business card can carry contact information of the user or serve the advertising purpose for restaurants or shops. The digital business card is not limited to static graphs or texts. One can embed objects such as animations or videos into the digital business card to complement static graphs and texts. Since each digital business card has a number, it will be convenient for other users to search for the card using the number.

The cloud server 20 mainly provides a business card sharing function and a business card updating function. These functions are described as follows.

The business card sharing function allows associated members to download each other's digital business card. The relation referred herein means that person A and person B set each other as friends. Before person A and person B become friends, person B can send an invitation letter to person A via the UI 11 on the cloud server 20 in order to invite person A to become a friend. The invitation letter includes personal data such as the name, phone number of person B. Person A can read person B's invitation letter on the cloud server 20 using his or her mobile device 10. If person A agrees to let person B become a friend, he or she can set person B as a friend on the cloud server 20 via the UI 11. Once person A and person B become friends, person A can grant person B the privilege to view a digital business card for person B to browse on line using a computer (e.g., desktop computer, laptop computer) to download person A's digital business card in the business card database 20 through the UI 11 on the mobile device 10.

For example, person A and person B have their own digital business cards in the business card database 22. After person A and person B set each other as friends, person A can enter the business card data of person B into his or her own mobile device. Person A then grants a digital business card viewing privilege to person B on the cloud server 20. Person B can then directly browse the digital business card of person A from the business card database 22 via the UI 11 and even download person A's digital business card to his or her own mobile device 10, thereby obtaining the business card data of person A. Therefore, as long as person A enters person B's business card data into his or her own mobile device and grants person B the privilege to view, person B can directly download person A's business card data from the business card database 22. This is a very convenient function for users.

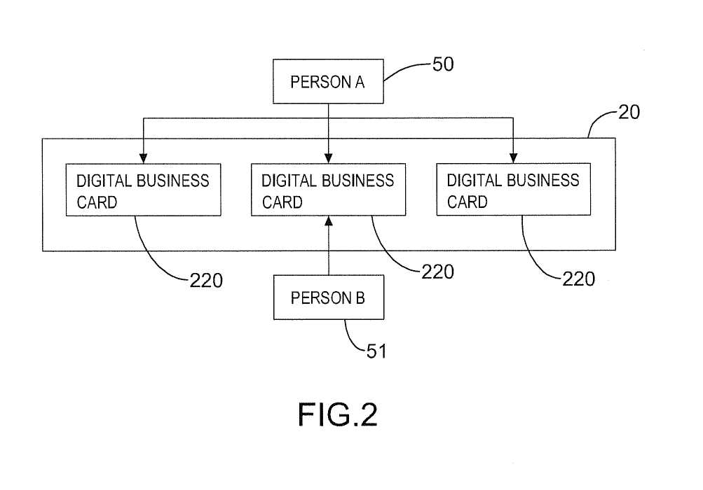

Likewise, a user can have many digital business cards and set the viewing privilege of each digital business card to specific friends. As shown in FIG. 2, for example, suppose person A 50 has three digital business cards 220. Only one digital business card 220 is allowed for person B 51 to view. Therefore, person B 51 can only view that particular digital business card 220 and cannot view or download the other two digital business cards 220.

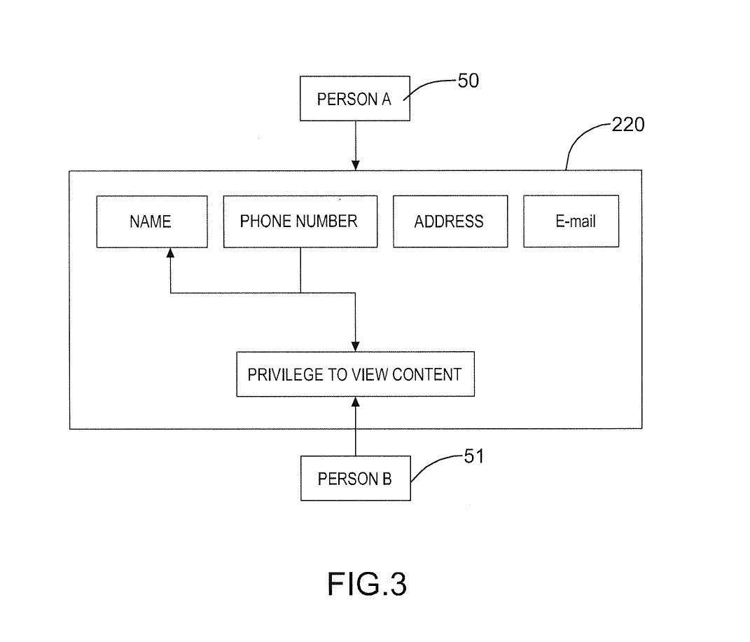

With reference to FIG. 3, person A 50 can set a content privilege for the content of a digital business card 220 so that friends of person A 51 can only view part of the information in the digital business card. For example, suppose person A 50 only grants person B 51 the privilege to view the name and phone number on the digital business card 220. Then person B 51 can only online browse or download the name and phone number of person A 50, but has no right to access other information. Consequently, the user can manage privileges to the content of his or her own digital business card, allowing different friends to have different degrees of accesses to the content of each of the digital business cards.

The business card updating function allows person B with the viewing privilege to obtain the latest digital business card of person A from the business card database 22. For example, suppose person A and person B are friends and person B has the privilege to view person A's digital business card. If person A changes the content of his or her digital business card (e.g., phone number, address, etc) and uploads and stores it in the business card database 22, the cloud server 20 sends a notification to the mobile device of person B so that person B immediately knows of the change in person A's digital business card. When person B online browses or downloads person A's digital business card from the business card database 22, the latest digital business card of person A is obtained. Person B does not need to modify or re-enter person A's digital business card in his or her own mobile device again, but has the most up-to-date information at any time.

The system allows each user to set at least one tag for his or her friends' digital business cards stored in his or her mobile device, thereby classifying the digital business cards of friends. The user can use the UI 11 to search for a particular tag to quickly find the digital business card of a particular friend. For example, the user sets ‘classmate’ and ‘friend’ tags for a digital business card. When the user enters the search keyword ‘classmate’ or ‘friend’ in the UI 11, that digital business card shows up in the search result. That is, a single digital business card can have more than one tag in order to more effectively classify all friends. Since the ‘classmate’ and ‘friend’ tags correspond to the digital business card of the same friend, instead of separate digital business cards, this method of having more than one tag for a digital business card can save storage space.

Furthermore, most of the mobile devices 10 nowadays have Bluetooth modules 12 for wireless data transfers. The system allows users to exchange digital business cards via the Bluetooth interface. For example, suppose person A and person B both turn on the Bluetooth function and connect to each other's mobile devices 10. The UI 11 of the invention shows personal digital business cards of each user. Person A can then select in the UI 11 the digital business card to be sent and transmit it to person B's mobile device. Person B can then receive and store person A's digital business card to his or her mobile device. This facilitates the exchange and storage of digital business cards.

The system further provides a business display function. The digital business cards in the business card database 22 include those provided by vendors for business purposes, including information of restaurants, shops, etc. The vendors can open the viewing privileges of the digital business cards to all members in the membership database 21. When a user executes the business display function on his or her mobile device 10, he or she can enter a keyword in the UI 11, such as the name, phone number, address, business hours, etc. The cloud server 20 then searches the keyword in the business card database 22.

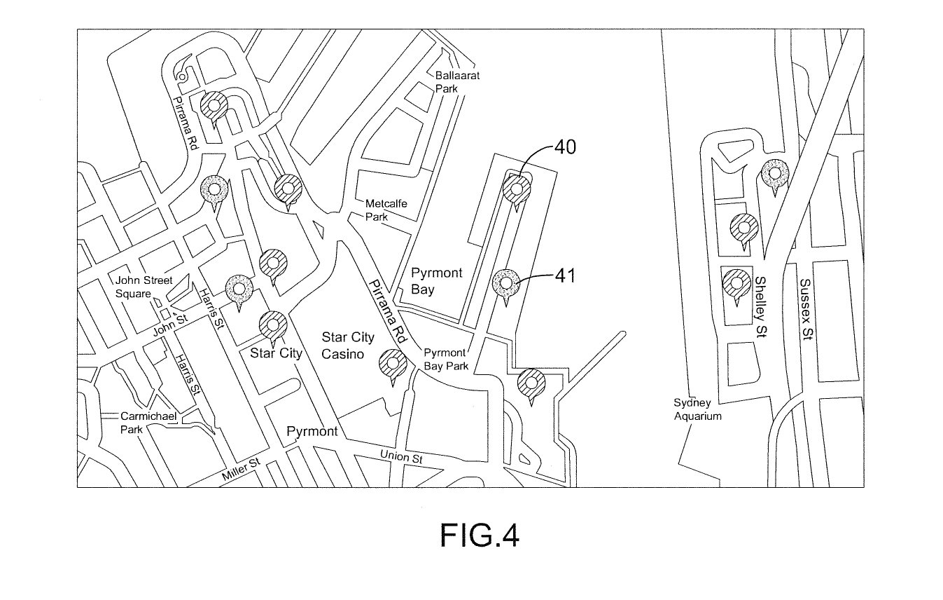

With reference to FIG. 4, a street map is used as a background and multiple shops matching the keywords are indicated by tags in the UI 11, with their business hours also displayed. In a preferred embodiment, the business hours are indicated by colors. The shops with a red tag 40 are those still open at the time of viewing. The shops with a yellow tag 41 are those to be closed within half an hour. Therefore, the user can use this function to quickly find shops that are still open or about to close. Besides, when the user clicks a particular shop in the UI 11, he or she can online view the digital business card of that shop and even download the digital business card to his or her own mobile device 10. This prevents the user from wasting time in filtering unnecessary information (e.g., sales, menus, etc.) of the shop obtained from website searching before the user obtains the relevant information of phone number, address and business hours thereof.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A digital business card management system for mobile devices, comprising:
a plurality of mobile devices, each of which is installed with an application program that provides a user interface (UI); and
a cloud server being connectable to the mobile devices, comprising a membership database and a business card database, the membership database storing multiple users' personal data, the business card database storing digital business cards that are edited by the user interface and uploaded from the mobile devices, and the cloud server further having:
a business card sharing function that enables person A in the membership database to enter business card data of person B to the mobile device of person A and to grant a privilege to person B for person B to directly online browse or download person A's digital business card from the business card database; and
a business card updating function that enables the cloud server to send a notification to friends of person A with the privilege to view the digital business card when the digital business card of person A has been updated.

2. The digital business card management system for mobile devices as claimed in claim 1, wherein the cloud server receives privilege setting commands from the user interfaces of the mobile devices to set the privilege for the digital business card in order to share the digital business card to other particular users.

3. The digital business card management system for mobile devices as claimed in claim 1, wherein the cloud server receives content privilege setting commands from the user interfaces of the mobile devices to set a content privilege for the digital business card so that only part of information of the digital business card is allowed to be online browsed and downloaded.

4. The digital business card management system for mobile devices as claimed in claim 2, wherein the cloud server receives content privilege setting commands from the user interfaces of the mobile devices to set a content privilege for the digital business card so that only part of information of the digital business card is allowed to be online browsed and downloaded.

5. The digital business card management system for mobile devices as claimed in claim 3, wherein the digital business card includes objects of animations or videos.

6. The digital business card management system for mobile devices as claimed in claim 4, wherein the digital business card includes objects of animations or videos.

7. The digital business card management system for mobile devices as claimed in claim 5, wherein the cloud server allows each user to set a plurality of tags on the digital business card of each friend thereof, thereby classifying the digital business cards of friends thereof.

8. The digital business card management system for mobile devices as claimed in claim 6, wherein the cloud server allows each user to set a plurality of tags on the digital business card of each friend thereof, thereby classifying the digital business cards of friends thereof.

9. The digital business card management system for mobile devices as claimed in claim 7, wherein each of the mobile devices has a Bluetooth module for wireless data transfers; the UI presents person A's digital business cards and transmits a selected digital business card to person B's mobile device.

10. The digital business card management system for mobile devices as claimed in claim 8, wherein each of the mobile devices has a Bluetooth module for wireless data transfers; the UI presents person A's digital business cards and transmits a selected digital business card to person B's mobile device.

11. The digital business card management system for mobile devices as claimed in claim 3, wherein the business card database includes digital business cards of shops; the cloud server provides a business display function that enables a user to enter a keyword in the UI, the UI shows a street map as a background and shops matching the keyword in the business card database, and the UI further shows the corresponding business hours displayed at the same time.

12. The digital business card management system for mobile devices as claimed in claim 4, wherein the business card database includes digital business cards of shops; the cloud server provides a business display function that enables a user to enter a keyword in the UI, the UI shows a street map as a background and shops matching the keyword in the business card database, and the UI further shows the corresponding business hours displayed at the same time.

13. The digital business card management system for mobile devices as claimed in claim 10, wherein the business card database includes digital business cards of shops; the cloud server provides a business display function that enables a user to enter a keyword in the UI, the UI shows a street map as a background and shops matching the keyword in the business card database, and the UI further shows the corresponding business hours displayed at the same time.

14. The digital business card management system for mobile devices as claimed in claim 11, wherein the business card database includes digital business cards of shops; the cloud server provides a business display function that enables a user to enter a keyword in the UI, the UI shows a street map as a background and shops matching the keyword in the business card database, and the UI further shows the corresponding business hours displayed at the same time.

15. The digital business card management system for mobile devices as claimed in claim 11, wherein each of the digital business cards has a corresponding number.

16. The digital business card management system for mobile devices as claimed in claim 12, wherein each of the digital business cards has a corresponding number.
